(19) United States
(12) Patent Application Publication
(10) Pub. No.: US 2024/0370290 A1
(43) Pub. Date: Nov. 7, 2024

(54) METHOD AND APPARATUS, DEVICE AND MEDIUM FOR USER-BASED SERVICE ISOLATION

(71) Applicant: Beijing Zitiao Network Technology Co., Ltd., Beijing (CN)

(72) Inventors: Xiaohua WANG, Beijing (CN); Chengye WEN, Beijing (CN)

(21) Appl. No.: 18/655,286

(22) Filed: May 5, 2024

(30) Foreign Application Priority Data
May 5, 2023 (CN) 202310500903.5

(51) Int. Cl. G06F 9/455; G06F 21/53

(52) U.S. Cl. CPC G06F 9/45558; G06F 21/53; G06F 2009/45562

(57) ABSTRACT

Embodiments of the present disclosure provides a user-based service isolation method and apparatus, a device and a medium. One specific implementation of the method includes: in response to login of a target user, constructing a user object corresponding to the target user, constructing a service container, binding the user object to the service container, and creating, in the service container, a service instance corresponding to the target user; and in response to logout of the target user, destroying the user object and the service container. By means of the method, the problem of a functional fault resulting from untimely user handover can be solved.

### CROSS-REFERENCE TO RELATED APPLICATION(S)

This application claims priority to Chinese Application No. 202310500903.5 filed May 5, 2023, the disclosure of which is incorporated herein by reference in its entity.

### FIELD

Embodiments of the present disclosure relate to the technical field of computer services and containers, and in particular to method and apparatus, device and medium for user-based service isolation.

### BACKGROUND

Program applications often need to switch between different user accounts and process user data based on the current user. User-based service isolation prevents unauthorized data access. The potential for risk can be significantly reduced by ensuring that users can only access their own data.

Through service isolation, the possibility of user's operational errors affecting other users can be reduced. User's misconfiguration will not affect other users' data or service stability. Service isolation strategies may simplify system maintenance and upgrades.

### SUMMARY

Embodiments of the present disclosure describe a method and apparatus, a device and a medium for user-based service isolation.

According to a first aspect, provided is a method for user-based service isolation, including: in response to login of a target user, constructing a user object corresponding to the target user, constructing a service container to bind the user object to the service container, and create, in the service container, a service instance corresponding to the target user; and in response to logout of the target user, destroying the user object and the service container.

According to a second aspect, provided is an apparatus for user-based service isolation, including: a first response unit, configured to: in response to login of a target user, construct a user object corresponding to the target user, construct a service container, bind the user object to the service container, and create, in the service container, a service instance corresponding to the target user; and a second response unit, configured to: in response to logout of the target user, destroy the user object and the service container.

According to a third aspect, provided is a computer-readable storage medium, storing a computer program thereon, wherein when the computer program is executed in a computer, the computer is caused to execute the method according to the first aspect.

According to a fourth aspect, provided is an electronic device, including a memory and a processor, wherein an executable code is stored in the memory, and the processor implements, when executing the executable code, the method according to the first aspect.

The embodiments of the present disclosure provide a user-based service isolation method and apparatus, a device and a medium. First, the user object corresponding to the target user may be constructed in response to the login of the target user, the service container is constructed, the user object is bound to the service container, and the service instance corresponding to the target user is created in the service container. Then, in response to the logout of the target user, the user object and the service container thereof may be destroyed. By using any of the method, the apparatus, the storage medium and the electronic device, the problem of a functional fault resulting from untimely user handover can be solved.

### BRIEF DESCRIPTION OF THE DRAWINGS

FIG. 1 illustrates a schematic diagram of a functional problem of untimely user handover;

FIG. 2 illustrates a schematic flowchart of a user-based service isolation method according to an embodiment of the present disclosure;

FIG. 3 illustrates a schematic diagram of creating and destroying a user container according to an embodiment of the present disclosure;

FIG. 4 illustrates a schematic diagram of sending a user identifier to a global service instance in another embodiment of the present disclosure;

FIG. 5 illustrates a schematic block diagram of a user-based service isolation apparatus according to an embodiment of the present disclosure;

FIG. 6 illustrates a schematic structural diagram of an electronic device suitable for implementing embodiments of the present disclosure; and

FIG. 7 illustrates a schematic structural diagram of a storage medium suitable for implementing embodiments of the present disclosure.

### DETAILED DESCRIPTION OF EMBODIMENTS

The technical solutions provided in the present specification are further described in detail below in combination with the drawings and embodiments. It can be understood that the specific embodiments described herein are merely used for explaining related invention, rather than limiting the invention. In addition, it should be noted that, for ease of description, only parts related to the related invention are shown in the drawings. It should be noted that, in the case of no conflict, embodiments of the present disclosure and features in the embodiments may be combined with each other.

In the description of implementations of the present disclosure, the term “include” and similar terms should be understood as open-ended inclusion, that is, “including, but not limited to”. The term “based on” should be understood as “based, at least in part, on”. The term “one implementation” or “the implementation” should be understood as “at least one implementation”. The term “some implementations” should be understood as “at least some implementations”. Other explicit and implicit definitions may also be included below.

As mentioned above, a program application often needs to switch between different user accounts, and perform user data processing according to a current user. However, this solution has the following problems that when the program application is switched from an old user to a new user, it is prone to a problem that data of an incorrect user is processed due to causes, for example, the old user is not immediately switched, or a parallel code based on the old user has not yet been executed, thus generating a functional fault of the application. These problems may be collectively referred to as an untimely user handover problem.

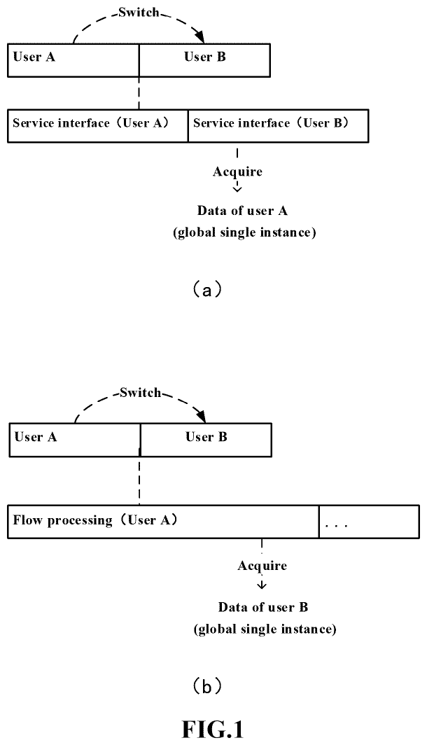

The cause to the above problem is that a service instance, which usually performs user data processing, for example, performing user data reading or executing user service logic, is a global instance. The global instance herein refers to a service instance that may exist in a life cycle of the entire application. The global instance typically determines, according to settings of a variable current user, to perform an operation according to the data of which specific user. However, the settings of the current user in the global instance and data processing performed according to the current user are often delayed or processed in parallel. Accordingly, for example, when an actual user has been switched, the settings of the current user in the global instance and the data processing performed according to the current user or partial data processing may still be based on the user who has not been switched, thereby resulting in the problem of the functional fault (e.g., a data display error, a data processing result error, and the like). FIG. 1 illustrates a schematic diagram of a functional problem of untimely user handover. As shown in FIG. 1 (a), for example, after a user A is switched to a user B, the data of the user B should be displayed on a user interface. However, since the settings of the current user in the global service instance are not updated in time, for example, the user is still the user A after a period of duration, so that the data or partial data of the user A is still displayed in the user interface within the period of duration. As shown in FIG. 1 (b), for example, after the user A is switched to the user B, the data of the user B should be processed in service flow processing. However, since the settings of the current user in the global service instance are not updated in time or the service flow processing itself is asynchronously executed, processing is stilled performed by the service flow processing according to the data of the user A within the period of duration.

In order to solve the above technical problems. Embodiments of the present disclosure provide a user-based service isolation method. In one embodiment, when a user logs in, a user object corresponding to the user may be constructed, a service container is constructed, and the user object corresponding to the user is bound to the service container. Then, a service instance corresponding to the user is created in the service container, and the service instance may perform data processing of the user. Then, when the user logs out, the user object, the service container and the service instance, which are destroyed. The method has the advantages that, on one hand, the data processing process for each user is isolated by the user object, the service container and the service instance, which correspond to each user, rather than executing the data processing process of all the users via a single global instance, thereby fundamentally eliminating the problem that the single global instance in existing solutions depends on the settings of the current user, such that the user data of an incorrect user is processed by mistake due to untimely user handover. On the other hand, since the single global instance in existing solutions depends on the current user, different users cannot be distinguished, resulting in difficulty in realizing simultaneous login of a plurality of users. Through the method in subsequent embodiments, service instances may also be established for the plurality of users respectively, and these service instances are isolated by using a plurality of containers, thereby supporting the simultaneous login of the plurality of users, and avoiding the problem that the service instance corresponding to each user processes the data of other users by mistake.

A detailed process of the method is further described below.

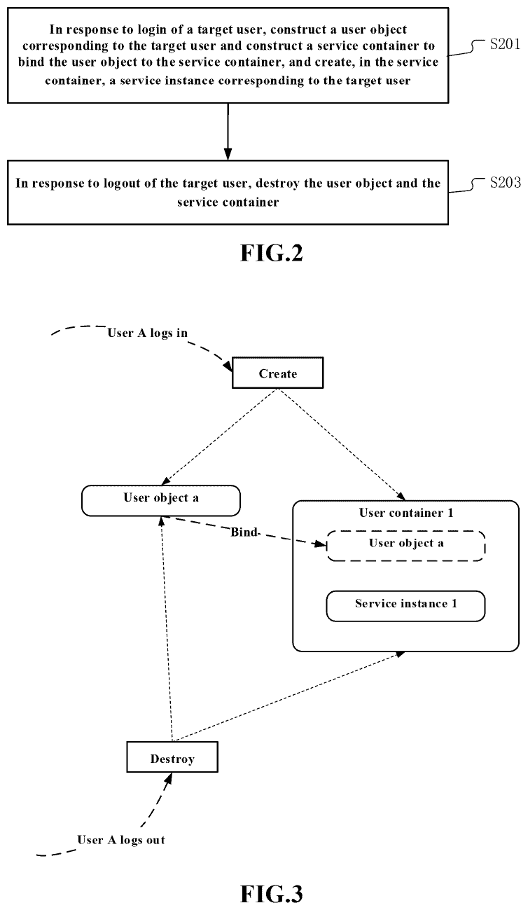

FIG. 2 illustrates a schematic flowchart of a user-based service isolation method according to an embodiment of the present disclosure. As shown in FIG. 2, the method includes at least the following steps:

Step S201, in response to login of a target user, constructing a user object corresponding to the target user, and constructing a service container to bind the user object to the service container, and create, in the service container, a service instance corresponding to the target user; and

Step S203, in response to logout of the target user, destroying the user object and the service container.

First, in step S201, in response to the login of the target user, the user object corresponding to the target user may be constructed, and the service container is constructed, the user object is bound to the service container, and the service instance corresponding to the target user is created in the service container. In different embodiments, the target user may be a different specific user, which is not limited in the present specification. The user object refers to a program object (Object) corresponding to the target user. The user object may encapsulate, into an entirety, data corresponding to the user. Conventionally, the program object may include attribute data (Attribute) or a function. In different embodiments, the attribute data of the user object may include different specific data of the target user. In one embodiment, the attribute data of the user object may include at least a user identifier of the target user, or referred to as a user ID (Identity).

A container technology is a sandbox technology, which may form, via running a program in a container, an environment isolated from the outside of the container. In different embodiments, different specific container technologies may be used, which is not limited in the present specification. A service may be a program running in a system. A service container is a container in which the service instance (Instance) may run. By constructing the user object corresponding to the target user and the service container, and binding the user object to the service container, the service container for the target user is actually created. When the service instance is created in the service container, the created service instance for the target user is isolated in the service container. In this way, the service instance can only process data and service logic of the target user, and a service instance outside the container is prevented from processing the data and service logic of the target user. FIG. 3 illustrates a schematic diagram of creating and destroying a user container according to an embodiment of the present disclosure. In the embodiment of FIG. 3, for example, when the user A logs in, a user object a corresponding to the user A, and a user container 1 are created, and the user object a is bound to the user container 1. Then, a service instance 1 is created in the user container 1 for data processing corresponding to the user A.

In different embodiments, the created service instance may be used for executing different data processing processes, for example, may be used for executing service logic processing or interface display based on user data, which is not limited in the present specification. In different embodiments, specific functional components included in the service instance may also be different. For example, in one embodiment, the service instance may include a user interface component for displaying, for example, user data. In another embodiment, the service instance may include a service logic component for executing service logic processing corresponding to the user. In yet another embodiment, the service instance may include a user interface component and a service logic component.

Then, at step S203, in response to the logout of the target user, the user object and the service container are destroyed.

At this step, when the target user logs out, the user object corresponding to the target user and the user container bound to the user object may be destroyed. In one embodiment, in response to the destruction of the service container, the service instance in the service container, that is, the service instance corresponding to the target user, may also be released. As shown in FIG. 3, for example, when the user A logs out, the user object a corresponding to the user A and the user container 1 are destroyed, and the service instance 1 in the user container 1 is released.

When the user (e.g., the target user) logs in and logs out, the service container corresponding to the user is created and destroyed, respectively. The service container, or referred to as a user container for short, corresponding to the life cycle of the user is actually constructed. Since the user container is bound to an invariant user object, and the life cycle of the user container is consistent with the life cycle for creating and destroying the bound user object, the service instance created in the user container is essentially a service instance for the same user. As such, it may be ensured that the service instance in the user container does not access and process the data of other users, thereby fundamentally eliminating the problem in the existing solutions that the single global instance operates the data of an incorrect user by mistake during user handover. In addition, in different embodiments, there may be a plurality of service instances created in the user container, which are respectively used for different data processing for the target user. Since they are all service instances for the same user, and these service instances may be invoked with each other, thereby also avoiding the problem of operating the data of an incorrect user by mistake.

In some scenarios, there may also be a global service instance related to the user in the application. As described above, the global service instance usually performs user data processing according to the current user corresponding thereto. In order to prevent a user data processing error caused by untimely handover of the current user in the global service instance, in one embodiment, after the target user logs in, if a target interface of a pre-running global service instance is invoked, a user identifier of the target user is transmitted to the target interface; and the target interface may determine, according to a user identifier of the current user corresponding to the global service instance and the user identifier of the target user, whether the current user corresponding to the global service instance is correct. In one specific embodiment, if the user identifier of the current user corresponding to the global service instance is different from the user identifier of the target user, it is determined that the current user is incorrect; and if the user identifier of the current user corresponding to the global service instance is the same as the user identifier of the target user, it is determined that the current user is correct. In another specific embodiment, the target interface may perform corresponding error processing, for example, sending a prompt of the current user being incorrect. The target interface of the global service instance is an application programming interface (API) of the global service instance. The application programming interface may be a performance function predefined in the global service instance, and a service function provided by the global service instance may be invoked by invoking the API interface. In different specific embodiments, specific application programming interfaces provided by the global service instance may be different and may be used for providing different specific service functions, which is not limited in the present specification.

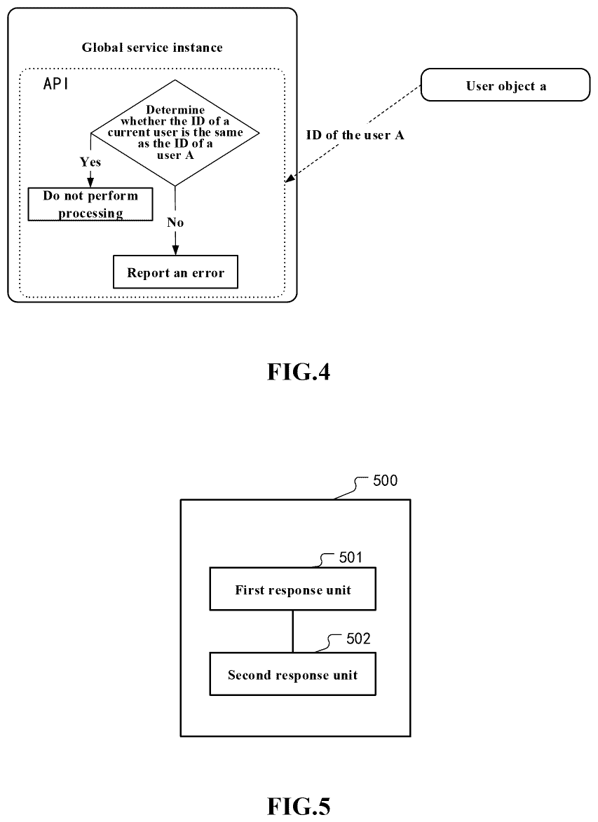

FIG. 4 illustrates a schematic diagram of sending a user identifier to a global service instance in another embodiment of the present disclosure. In the embodiment shown in FIG. 4, for example, after the user A logs in, when the application programming interface of the global instance is invoked, the ID of the user A may be sent to the invoked application programming interface. Then, the invoked application programming interface may determine whether the ID of the current user of the global service instance is the same as the ID of the user A. If the determination result is that the ID of the current user of the global service instance is the same as the ID of the user A, it indicates that the current user of the global service instance is correct, the global service instance may continue to run normally, and three is no need to perform additional processing. If the determination result is that the ID of the current user of the global service instance is different from the ID of the user A, it indicates that the current user representing the global service instance is incorrect, and then an error prompt, for example, the current user being incorrect, may be sent.

In some scenarios, software manufacturers also expect that the application has a function of enabling a plurality of users to log in at the same time. As described above, the existing user data processing process often relies on the current user, and cannot distinguish different users, resulting in difficulty in realizing the simultaneous login of the plurality of users. In order to enable the plurality of users to log in at the same time, in one embodiment, a plurality of objects respectively corresponding to the plurality of users may be also constructed, a plurality of containers is constructed, the plurality of objects is respectively bound to the plurality of containers, and service instances respectively corresponding to the plurality of users are respectively created in the plurality of containers. In this way, a plurality of logged users may have corresponding service instances respectively, and the service instances of different users run in different user containers, therefore not only can the login of the plurality of users be supported, but the service instances for user data processing of different users may also be isolated, thereby preventing the service instances of different users from operating the user data of other users by mistake.

FIG. 5 illustrates a schematic block diagram of a user-based service isolation apparatus according to an embodiment of the present disclosure. The apparatus is used for executing the method shown in FIG. 3, and as shown in FIG. 5, the apparatus 500 includes:
a first response unit 501, configured to in response to login of a target user, construct a user object corresponding to the target user and construct a service container to bind the user object to the service container, and create, in the service container, a service instance corresponding to the target user; and
a second response unit 502, configured to in response to logout of the target user, destroy the user object and the service container.

An embodiment of the present disclosure further provides an electronic device, including a memory and a processor, wherein an executable code is stored in the memory, and the processor implements, when executing the executable code, the method shown in FIG. 2.

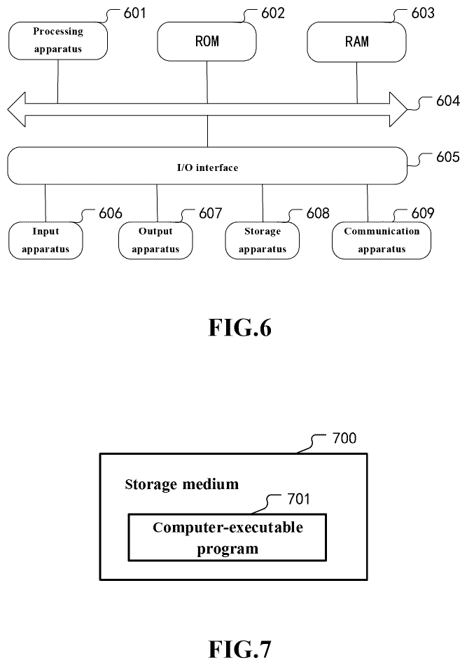

Reference may also be made to FIG. 6, which illustrates a schematic structural diagram of an electronic device 800 suitable for implementing embodiments of the present disclosure. The electronic device 600 shown in FIG. 6 is merely an example, and should not bring any limitation to the functions and usage scopes of the embodiments of the present application.

As shown in FIG. 6, the electronic device 600 may include a processing apparatus (e.g., a central processing unit, a graphics processing unit, or the like) 601. The processing apparatus 601 may be a general-purpose processor, a digital signal processor (DSP), a micro-processor or a micro-controller, and may further include an application specific integrated circuit (ASIC), a field-programmable gate array (FPGA) or other programmable logic devices, a discrete gate or transistor logic device, or a discrete hardware component, which may execute various appropriate actions and processing according to a program stored in a read-only memory (ROM) 602 or a program loaded from a storage apparatus 608 into a random access memory (RAM) 603. In the RAM 603, various programs and data needed by the operations of the electronic device 600 are also stored. The processing apparatus 601, the ROM 602 and the RAM 603 are connected with each other via a bus 604. An input/output (I/O) interface 605 is also connected to the bus 604.

In general, the following apparatuses may be connected to the I/O interface 605: an input apparatus 606, including, for example, a touch screen, a touch pad, a keyboard, a mouse, and the like; an output apparatus 607, including, for example, a liquid crystal display (LCD), a speaker, a vibrator, and the like; the storage apparatus 608, including, for example, a magnetic tape, a hard disk, and the like; and a communication apparatus 609. The communication apparatus 609 may allow the electronic device 600 to communicate in a wireless or wired manner with other devices to exchange data. Although FIG. 7 illustrates the electronic device 600 having various apparatuses, it should be understood that not all illustrated apparatuses are required to be implemented or provided. More or fewer apparatuses may alternatively be implemented or provided. Each block shown in FIG. 6 may represent one apparatus, and may also represent a plurality of apparatuses as needed.

In particular, according to the embodiments of the present application, the processes described above with reference to the flowcharts may be implemented as computer software programs. For example, the embodiments of the present application include a computer program product, which includes a computer program carried on a computer-readable medium, and the computer program contains program codes for executing the method illustrated in the flowcharts. In such embodiments, the computer program may be downloaded and installed from a network via the communication apparatus 609, or installed from the storage apparatus 608, or installed from the ROM 602. When the computer program is executed by the processing apparatus 601, the above functions defined in the user-based service isolation method provided in the embodiments of the present application are executed.

An embodiment of the present disclosure further provides a computer-readable storage medium, storing a computer program thereon, wherein when the computer program is executed in a computer, the computer is caused to execute the user-based service isolation method shown in FIG. 2 according to the embodiments of the present application. FIG. 7 is a schematic diagram of a storage medium for implementing the embodiments of the present application. For example, as shown in FIG. 7, the storage medium 700 may be a non-transitory computer-readable storage medium used for storing a non-transitory computer-executable instruction 701. When the non-transitory computer-executable instruction 701 is executed by the processor, the user-based service isolation method provided in the embodiments of the present application may be implemented, for example, when the non-transitory computer-executable instruction 701 is executed by the processor, one or more steps in the user-based service isolation method provided according to the embodiments of the present application may be executed. For example, the storage medium 700 may be applied to the above electronic device, for example, the storage medium 700 may include a memory in the electronic device. Regarding the description of the storage medium 700, reference may be made to the description of the memory in the embodiment of the electronic device, and thus details are not repeated herein again. Regarding specific functions and technical effects of the storage medium 700, reference may be made to the description of the user-based service isolation method provided in the embodiments of the present application, and thus details are not described herein again.

It should be noted that, the computer-readable medium in the embodiments of the present disclosure may be either a computer-readable signal medium or a computer-readable storage medium, or any combination of the two. The computer-readable storage medium may be, for example, but is not limited to, an electrical, magnetic, optical, electromagnetic, infrared, or semiconductor system, apparatus or device, or a combination of any of the above. More specific examples of the computer-readable storage medium may include, but are not limited to: an electrical connection having one or more wires, a storage card of a smart phone, a storage component of a tablet computer, a portable computer magnetic disk, a hard disk of a personal computer, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof. In the embodiments of the present disclosure, the computer-readable storage medium may be any tangible medium that contains or stores a program, wherein the program may be used by or in combination with an instruction execution system, apparatus or device. In the embodiments of the present disclosure, the computer-readable signal medium may include a data signal that is propagated in a baseband or used as part of a carrier, wherein the data signal carries computer-readable program codes. Such propagated data signal may take many forms, including, but not limited to, electromagnetic signals, optical signals, or any suitable combination thereof. The computer-readable signal medium may also be any computer-readable medium other than the computer-readable storage medium, and the computer-readable signal medium may send, propagate or transport the program for use by or in combination with the instruction execution system, apparatus or device. Program codes contained on the computer-readable medium may be transmitted with any suitable medium, including, but not limited to: an electrical wire, an optical cable, RF (radio frequency), and the like, or any suitable combination thereof.

The computer-readable medium may be contained in the above electronic device; and it may also be present separately and is not assembled into the electronic device. The computer-readable medium carries one or more programs that, when executed by the server, cause the electronic device to implement the user-based service isolation method provided in the embodiments of the present application.

Computer program codes for executing the operations of the embodiments of the present disclosure may be written in one or more programming languages or combinations thereof. The programming languages include object-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or a server. In the case involving the remote computer, the remote computer may be connected to the user computer via any type of network, including a local area network (LAN) or a wide area network (WAN), or it may be connected to an external computer (e.g., via the Internet using an Internet service provider).

The flowcharts and block diagrams in the drawings illustrate system architectures, functions and operations of possible implementations of systems, methods and computer program products according to various embodiments of the present disclosure. In this regard, each block in the flowcharts or block diagrams may represent a part of a module, a program segment or a code, and the part of the module, the program segment or the code contains one or more executable instructions for implementing specified logic functions. It should also be noted that, in some alternative implementations, the functions annotated in the blocks may occur out of the sequence annotated in the drawings. For example, two blocks shown in succession may, in fact, be executed substantially concurrently, or the blocks may sometimes be executed in a reverse sequence, depending upon the functions involved. It should also be noted that each block in the block diagrams and/or flowcharts, and combinations of the blocks in the block diagrams and/or flowcharts may be implemented by dedicated hardware-based systems for executing specified functions or operations, or combinations of dedicated hardware and computer instructions. The units involved in the described embodiments of the present disclosure may be implemented in a software or hardware manner. The names of the units do not constitute limitations of the units themselves in a certain case. The functions described herein above may be executed, at least in part, by one or more hardware logic components. For example, without limitation, example types of the hardware logic components that may be used include: a field programmable gate array (FPGA), an application specific integrated circuit (ASIC), an application specific standard product (ASSPs), a system on chip (SOC), a complex programmable logic device (CPLD), and so on.

Various embodiments in the present specification are all described in a progressive manner, the identical or similar parts between the embodiments refer to each other, and what is highlighted in each embodiment is difference with other embodiments. In particular, for the embodiments of the storage medium and the computing device, they are basically similar to the method embodiments, thus are described simply, and for related parts, reference may be made to some descriptions of the method embodiments.

What have been described above are only preferred embodiments of the present disclosure and illustrations of the technical principles employed. It should be understood by those skilled in the art that, the disclosure scope involved in the preset disclosure is not limited to the technical solutions formed by specific combinations of the above technical features, and meanwhile should also include other technical solutions formed by any combinations of the above technical features or equivalent features thereof without departing from the concept of the disclosure, for example, technical solutions formed by mutual replacement of the above features with technical features having similar functions disclosed in the present disclosure (but is not limited to). In addition, although various operations are described in a particular order, this should not be understood as requiring that these operations are executed in the particular sequence shown or in a sequential order. In certain environments, multitasking and parallel processing may be advantageous. Similarly, although several specific implementation details have been contained in the above discussion, these should not be construed as limiting the scope of the present disclosure. Some features that are described in the context of separate embodiments may also be implemented in combination in a single embodiment. Conversely, various features that are described in the context of a single embodiment may also be implemented in a plurality of embodiments separately or in any suitable sub-combination.

The objectives, technical solutions and beneficial effects of the embodiments of the present invention are further described in detail in the above specific implementations. Although the present theme has been described in language specific to structural features and/or methodological actions, it should be understood that the theme defined in the appended claims is not necessarily limited to the specific features or actions described above. Rather, the specific features and actions described above are merely example forms of implementing the claims. It should be understood that the foregoing descriptions are only specific implementations of the embodiments of the present invention, and are not intended to limit the protection scope of the present invention, and any modifications, equivalent replacements, improvements and the like, made on the basis of the technical solutions of the present invention, shall fall within the protection scope of the present invention.

I/We claim:

1. A user-based service isolation method, comprising:
in response to login of a target user, constructing a user object corresponding to the target user, and constructing a service container to, bind the user object to the service container and create, in the service container, a service instance corresponding to the target user; and
in response to logout of the target user, destroying the user object and the service container.

2. The method of claim 1, wherein attribute data of the user object comprises at least a user identifier of the target user.

3. The method of claim 1, wherein the service instance comprises a user interface component and/or a service logic component.

4. The method of claim 1, further comprising:
in response to destruction of the service container, releasing the service instance corresponding to the target user.

5. The method of claim 1, further comprising:
after the target user logs in, if a target interface of a pre-running global service instance is invoked, transmitting the user identifier of the target user to the target interface; and
the target interface determining, according to a user identifier of a current user corresponding to the global service instance and the user identifier of the target user, whether the current user corresponding to the global service instance is correct.

6. The method of claim 5, wherein the target interface determining, according to the user identifier of the current user corresponding to the global service instance and the user identifier of the target user, whether the current user corresponding to the global service instance is correct, comprises:
if the user identifier of the current user corresponding to the global service instance is different from the user identifier of the target user, determining that the current user is incorrect; and
if the user identifier of the current user corresponding to the global service instance is the same as the user identifier of the target user, determining that the current user is correct.

7. The method of claim 5, further comprising:
after determining that the current user is incorrect, the target interface throwing a prompt of the current user being incorrect.

8. The method of claim 1, further comprising:
constructing a plurality of objects respectively corresponding to a plurality of users, and constructing a plurality of containers to respectively bind the plurality of objects to the plurality of containers, and respectively create, in the plurality of containers, service instances respectively corresponding to the plurality of users.

9. A computer-readable storage medium, storing a computer program thereon, wherein when the computer program is executed in a computer, the computer is caused to execute the method, comprising:
in response to login of a target user, constructing a user object corresponding to the target user, and constructing a service container to, bind the user object to the service container and create, in the service container, a service instance corresponding to the target user; and
in response to logout of the target user, destroying the user object and the service container.

10. The medium of claim 9, wherein attribute data of the user object comprises at least a user identifier of the target user.

11. The medium of claim 9, wherein the service instance comprises a user interface component and/or a service logic component.

12. The medium of claim 9, further comprising:
in response to destruction of the service container, releasing the service instance corresponding to the target user.

13. The medium of claim 9, further comprising:
after the target user logs in, if a target interface of a pre-running global service instance is invoked, transmitting the user identifier of the target user to the target interface; and
the target interface determining, according to a user identifier of a current user corresponding to the global service instance and the user identifier of the target user, whether the current user corresponding to the global service instance is correct.

14. The medium of claim 13, wherein the target interface determining, according to the user identifier of the current user corresponding to the global service instance and the user identifier of the target user, whether the current user corresponding to the global service instance is correct, comprises:
if the user identifier of the current user corresponding to the global service instance is different from the user identifier of the target user, determining that the current user is incorrect; and
if the user identifier of the current user corresponding to the global service instance is the same as the user identifier of the target user, determining that the current user is correct.

15. The medium of claim 13, further comprising:
after determining that the current user is incorrect, the target interface throwing a prompt of the current user being incorrect.

16. The medium of claim 9, further comprising:
constructing a plurality of objects respectively corresponding to a plurality of users, and constructing a plurality of containers to respectively bind the plurality of objects to the plurality of containers, and respectively create, in the plurality of containers, service instances respectively corresponding to the plurality of users.

17. An electronic device, comprising a memory and a processor, wherein an executable code is stored in the memory, and the processor implements, when executing the executable code, the method comprising:
in response to login of a target user, constructing a user object corresponding to the target user, and constructing a service container to, bind the user object to the service container and create, in the service container, a service instance corresponding to the target user; and
in response to logout of the target user, destroying the user object and the service container.

18. The electronic device of claim 17, wherein attribute data of the user object comprises at least a user identifier of the target user.

19. The electronic device of claim 17, wherein the service instance comprises a user interface component and/or a service logic component.

20. The electronic device of claim 17, further comprising:
in response to destruction of the service container, releasing the service instance corresponding to the target user.
